(19) United States
(12) Patent Application Publication
(10) Pub. No.: US 2022/0128457 A1
(43) Pub. Date: Apr. 28, 2022

(54) APPARATUS AND METHOD FOR CARRYING OUT SPATIALLY RESOLVED PHOTOACOUSTICS

(71) Applicant: TRUMPF GmbH + Co. KG, Ditzingen (DE)

(72) Inventor: Andreas Popp, Markgroeningen (DE)

(21) Appl. No.: 17/570,434

(22) Filed: Jan. 7, 2022

Related U.S. Application Data
(63) Continuation of application No. PCT/EP2020/069141, filed on Jul. 7, 2020.

(30) Foreign Application Priority Data
Jul. 9, 2019 (DE) 10 2019 210 073.2

(51) Int. Cl. G01N 21/17; G01N 29/24

(52) U.S. Cl. CPC G01N 21/1702; G01N 29/2418

(57) ABSTRACT

An apparatus for carrying out spatially resolved photoacoustics includes a sample holder configured to receive a sample to be examined, an electroacoustic transducer in the region of the sample holder configured to detect acoustic waves excited by light beams on the sample, and a light beam device configured to emit a plurality of light beams that are spatially and temporally separated from one another onto the sample in order to generate acoustic waves at spatially separated positions on the sample.

### CROSS REFERENCE TO RELATED APPLICATIONS

This application is a continuation of International Application No. PCT/EP2020/069141 (WO 2021/005068 A1), filed on Jul. 7, 2020, and claims benefit to German Patent Application No. DE 10 2019 210 073.2, filed on Jul. 9, 2019. The aforementioned applications are hereby incorporated by reference herein.

### FIELD

The disclosure relates to an apparatus and a method for carrying out spatially resolved photoacoustics.

### BACKGROUND

It is known to use photoacoustic spectroscopy or photoacoustic imaging for examining a sample. These are non-invasive methods that enable the structural, functional and/or molecular analysis of a sample.

The methods are based on the photoacoustic effect, i.e. the conversion of light into sound waves as a result of the absorption of electromagnetic waves. In this case, the local absorption of light leads to the abrupt local heating of the sample and thermal expansion resulting therefrom. Acoustic waves, particularly in the ultrasonic range, are generated as a result. The acoustic waves are measured by means of an electroacoustic transducer. In other words, a sample to be examined is excited with light and the acoustic response of the sample is detected by means of a microphone in order to detect defects of the sample, for example.

The known apparatuses provide for scanning the sample point by point in a very time-consuming way. Such apparatuses have been disclosed by DE 10 2014 012 364 B4, U.S. Pat. No. 6,590,661 B1 and US 2014/0050489 A1, for example.

### SUMMARY

In an embodiment, the present disclosure provides an apparatus for carrying out spatially resolved photoacoustics. The apparatus includes a sample holder configured to receive a sample to be examined, an electroacoustic transducer in the region of the sample holder configured to detect acoustic waves excited by light beams on the sample, and a light beam device configured to emit a plurality of light beams that are spatially and temporally separated from one another onto the sample in order to generate acoustic waves at spatially separated positions on the sample.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic elucidation of the photoacoustic effect;

FIG. 2 shows a schematic side view of a first embodiment of an apparatus for carrying out a photoacoustic measurement using the photoacoustic effect in accordance with FIG. 1;

FIG. 3 shows a schematic partial plan view of a further embodiment of an apparatus for carrying out a photoacoustic measurement;

FIG. 4 shows the profile of refractive indices of various glasses versus the wavelength of light radiating through the glasses, wherein the glasses are able to be used in the apparatuses in accordance with FIG. 2 or 3; and

FIG. 5 shows a schematic plan view of a further embodiment of an apparatus for carrying out a photoacoustic measurement.

### DETAILED DESCRIPTION

Against this background, the present disclosure provides an apparatus and a method for carrying out spatially resolved photoacoustics, the photoacoustics being able to be carried out or being carried out particularly rapidly, efficiently and thus cost-effectively.

The present disclosure provides an apparatus for carrying out photoacoustic spectroscopy and/or photoacoustic imaging. The apparatus comprises a sample holder for arranging a sample, a light beam device for illuminating the sample, and an electroacoustic transducer, i.e. a “microphone”, for detecting acoustic waves generated on the sample. The light beam device is configured to emit a plurality of, in particular parallel, spatially and temporally separated light beams or light pulses onto the sample. In this case, the light beam device is preferably configured to space the light beams apart from one another by less than 1 μs, preferably between 0.1 ns and 10 ns, in particular between 0.4 ns and 4 ns, particularly preferably between 0.5 ns and 1 ns. As a result of the practically simultaneous irradiation of a plurality of points of the sample with a plurality of light beams, the apparatus is able to rapidly measure a large region of the sample. In this case, however, as a result of the light beams being minimally temporally retarded with respect to one another, the apparatus can still assign the individual detection results of the electroacoustic transducer in each case to a specific distance between the sample points and the electroacoustic transducer, i.e. to a specific location on the sample.

The sample can be part of the apparatus.

The light source can be configured in the form of a laser.

In a particularly preferred embodiment, the light beam device comprises a single light source, in particular in the form of a laser, for emitting a primary light beam and a beam splitter for splitting the primary light beam into a plurality of secondary light beams that are spatially separated from one another. The beam splitter can be configured to split the primary light beam into more than two, in particular more than 5, preferably more than 10, secondary light beams.

The beam splitter can be configured to form secondary light beams that are spaced apart from one another in two different directions. The directions can be perpendicular to one another. In other words, the light beams propagate in mutually parallel directions of propagation, the light beams being laterally offset with respect to one another. The beam splitter then forms a multi-light spot array extending in the area. The beam splitter makes it possible to carry out, instead of one pointlike excitation, an excitation with a multiplicity of punctiform excitations in the area.

The light beam device can be configured to irradiate the sample with punctiform secondary light beams. A particularly precise spatial assignment of the acoustic waves can be effected as a result.

With further preference, the light beam device comprises a beam deceleration device disposed downstream of the beam splitter. The beam deceleration device comprises at least one beam decelerator that decelerates a secondary light beam, such that the secondary light beam that passes through the beam decelerator reaches the sample later than another secondary light beam that does not pass through the beam decelerator. The use of a single light source, the light of which is split into a plurality of light beams and the latter are retarded differently, allows the structurally simple and particularly cost-effective configuration of the apparatus.

In a further preferred embodiment of the apparatus, the beam deceleration device comprises a multiplicity of in each case differently retarding beam decelerators. As a result, a large sample region can be photoacoustically measured practically simultaneously with high resolution.

The beam decelerators need not each be at an individual distance from the electroacoustic transducer. By way of example, two beam decelerators can be at the same distance from the electroacoustic transducer, but can retard the respective secondary light beams to such different extents that an unambiguous assignment of the signals initiated by the respective secondary light beams is nevertheless possible. In order to facilitate the assignment of the secondary light beams passing through the respective beam decelerators, however, the beam decelerators are preferably each at an individual distance from the electroacoustic transducer.

The apparatus can comprise a collimator in order to illuminate the beam splitter uniformly.

The beam decelerators are particularly preferably arranged or configured at the beam deceleration device in such a way that the retardations by the respective beam decelerators increase as the distance from the center point of the beam deceleration device increases. This is significant particularly in the case of an electroacoustic transducer arranged centrally in the region of the beam deceleration device. This is because otherwise it can happen that the light beams emitted further from the center point of the beam deceleration device do arrive on the sample more rapidly than the light beams in the region of the center point of the sample. However, the acoustic signal propagation times of the acoustic waves excited further from the center point to the electroacoustic transducer are longer, and so it can happen that the two effects (rapid impingement of the light on the sample but slow propagation on the sample) compensate for one another, as a result of which the signals recorded by the electroacoustic transducer cannot be assigned to a precise location on the sample.

The apparatus can comprise beam decelerators arranged or configured offset with respect to one another in the form of a two-dimensional matrix, that is to say in two different directions of a plane. As a result, the sample can be irradiated in areal fashion.

The beam decelerators can be arranged or configured equidistantly with respect to their nearest neighboring beam decelerators, in order to be able to examine the sample uniformly.

A beam decelerator can comprise plastic, in particular a high refractive index plastic. A beam decelerator can comprise a high refractive index glass in order that the secondary light beam passing through the beam decelerator is retarded particularly effectively. Preferably, the majority of the beam decelerators, in particular all of the beam decelerators, comprise a high refractive index plastic and/or a high refractive index glass. The refractive index of the high refractive index glass for light in the visible range is preferably greater than 1.6, in particular greater than 1.65. By way of example, flint F2, dense flint SF10, lanthanum dense flint LaSF9 and/or polycarbonate can be used as high refractive index glass.

As an alternative or in addition thereto, a beam decelerator can comprise a fiber that is transparent to the light used, in particular an optical fiber. Preferably, the majority of the beam decelerators, in particular all of the beam decelerators, comprise such a fiber. The fiber can be configured in the form of a solid-core fiber or a hollow-core fiber. Particularly preferably, all fibers of the beam decelerators in each case have a different length.

At least two, in particular the majority, preferably all, of the beam decelerators can be formed from the same material. In this case, the beam decelerators are preferably configured with different lengths in the radiation-transmission direction. As a result, the beam deceleration device can be configured in a particularly simple manner structurally.

In a further advantageous configuration, because it is particularly simple structurally, the beam deceleration device comprises a plate that is transparent to the secondary light beams used. At least one beam decelerator, in particular a plurality of beam decelerators, preferably all of the beam decelerators, can be arranged or—preferably—configured at the plate. The plate can be configured as fully transparent.

In this case, the beam deceleration device is particularly preferably configured in an integral fashion.

The beam deceleration device can be nailed, clamped together or adhesively bonded from different optical components, and/or configured by means of a 3D printer.

In order to optimize the optical transmissivity of the beam deceleration device, the beam deceleration device can comprise an antireflection coating on its side facing and/or facing away from the beam splitter.

The beam splitter can comprise a diffractive optical element (DOE) and/or a microlens array for splitting the primary light beam into the secondary light beams. The beam splitter can be configured in the form of a diffractive optical element and/or in the form of a microlens array.

In order that the assignment of the acoustic signal arriving at a specific time can be assigned to a position on the sample in the simplest possible manner, the electroacoustic transducer is preferably arranged centrally with respect to the sample, in particular centrally with respect to the sample holder. The electroacoustic transducer can be arranged or configured centrally on or in the beam deceleration device. Particularly preferably, the electroacoustic transducer is integrated into the beam deceleration device.

The electroacoustic transducer can be configured as described in DE 10 2006 013 345 B4 and/or EP 2 039 215 B1, to the content of which reference is fully made. The disclosure content of DE 10 2006 013 345 B4 and of EP 2 039 215 B1 is incorporated in its entirety in the present description.

In order to keep the apparatus structurally simple, the apparatus preferably comprises only a single electroacoustic transducer for detecting the acoustic waves generated on the sample.

The apparatus can comprise an oscilloscope for processing and/or representing the output signal output by the electroacoustic transducer. The oscilloscope is preferably configured to attain more than 1 Gsample/s, in particular more than 10 Gsamples/s, preferably more than 100 Gsamples/s. As a result, acoustic waves with a particularly small temporal offset with respect to one another can still be assessed separately from one another and assigned to spatial positions of the sample.

One or more further optical elements, for example focusing lenses, can be arranged in the beam path of the apparatus.

In a preferred embodiment, the beam splitter is configured in the form of a fiber splitter. Particularly preferably, both the beam splitter and the beam deceleration device are configured in fiber-optic fashion. As a result, overall from a structural standpoint the apparatus can be configured particularly simply and cost-effectively.

The object is furthermore achieved by means of a method for photoacoustic imaging and/or photoacoustic spectroscopy, in particular by means of an apparatus described here, wherein the method comprises the following method steps:
A) splitting a primary light beam into a plurality of secondary light beams;
B) illuminating, in particular in pointlike fashion, a sample with the secondary light beams, wherein at least one secondary light beam is decelerated in relation to a further secondary light beam, such that it impinges on the sample after the further secondary light beam;
C) detecting acoustic waves excited on the sample by the secondary light beams using an electroacoustic transducer.

One or more further method steps can be carried out before, after or between the method steps described above.

In the method, a laser beam can be used as primary light beam.

Preferably, a pulsed light beam is used as primary light beam in the method. The pulse duration is preferably less than 1000 ns, in particular less than 100 ns, particularly preferably less than 10 ns.

In one preferred variant of the method, two secondary light beams, in particular two adjacent secondary light beams, are retarded by between 0.01 ns and 50 ns with respect to one another. With further preference, in the method, the majority of the secondary light beams, in particular all of the secondary light beams, are in each case retarded by between 0.01 ns and 10 ns with respect to another secondary light beam.

Further advantages are evident from the following description and the drawings. Likewise, the features mentioned above and those that will be explained still further can be used in each case individually by themselves or as a plurality in any desired combinations. The embodiments shown and described should not be understood as an exhaustive enumeration, but rather are of exemplary character.

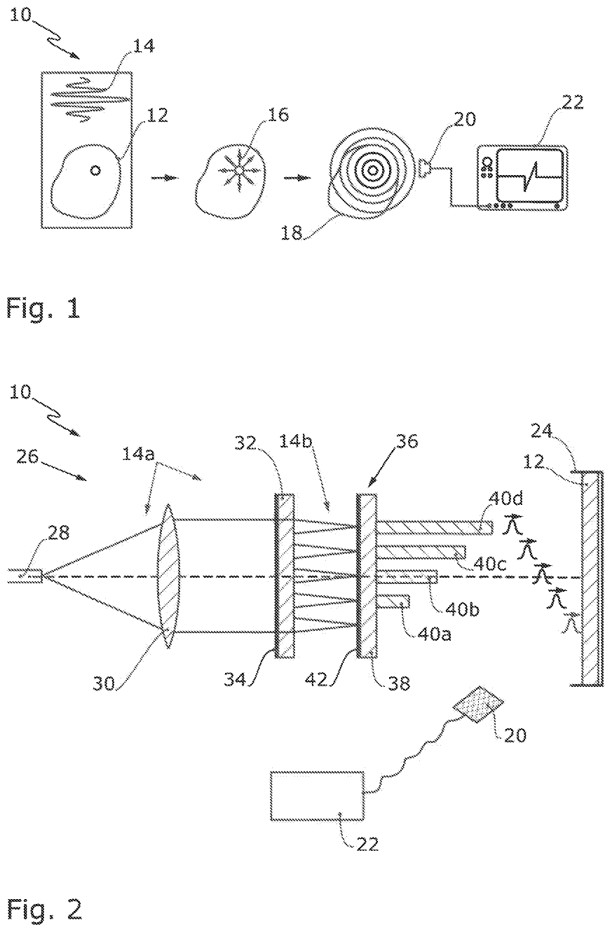

FIG. 1 shows an apparatus 10 for using photoacoustics when analyzing a sample 12. In this case, the sample 12 is irradiated with a light beam 14, in particular in the form of a light pulse, preferably in the form of a laser pulse. The light beam 14 absorbed in the sample 12 leads to a thermal expansion 16 and further to an acoustic wave 18. The latter can generate an electrical signal in an electroacoustic transducer 20, said electrical signal being represented in an oscilloscope 22.

If a relatively large region of the sample 12 is intended to be examined using the apparatuses known from the prior art, then the light beam 14 has to be shifted examination point by examination point (not illustrated in FIG. 1). The examination becomes very time-consuming and expensive as a result.

FIG. 2 shows a first embodiment of an apparatus 10. The apparatus 10 comprises a sample holder 24 for receiving the sample 12. For the purpose of examining the sample 12, the apparatus 10 comprises a light beam device 26. The light beam device 26 comprises a light source 28, here a single light source 28. The light source 28 can be configured in the form of a laser light source. Preferably, the light source 28 is configured to emit light pulses, in particular light pulses having a duration of less than 100 ns, preferably of less than 10 ns. The light source 28 generates a primary light beam 14a, which preferably consists of a multiplicity of light pulses. The primary light beam 14a can be shaped by a collimator 30.

The primary light beam 14a impinges on a beam splitter 32, which splits the primary light beam 14a into a plurality of, in particular more than 5, preferably more than 10, particularly preferably more than 15, secondary light beams 14b. The beam splitter 32 is preferably configured in the form of a planar diffractive optical element or in the form of a planar microlens array. With further preference, the beam splitter 32 is configured in an integral fashion. The beam splitter 32 is preferably configured in areal fashion, and emits secondary light beams 14b spaced apart from one another in two different directions. In other words, the beam splitter 32 is configured to form a multi-light spot array, in particular in the form of a multi-laser spot array, composed of secondary light beams 14b. In order to increase the effectiveness of the beam splitter 32, the latter can comprise an antireflection coating 34 on its input side.

A beam deceleration device 36 is disposed indirectly or—preferably—directly downstream of the beam splitter 32. The beam deceleration device 36 can comprise a plate 38. The plate 38 is configured such that it is transparent to the secondary light beams 14b on its input side at least in the region in which the secondary light beams 14b impinge. Beam decelerators 40a, 40b, 40c, 40d can be arranged or configured at the plate 38. The beam decelerators 40a-40d are preferably configured in block-shaped or rod-shaped fashion. Preferably, all the beam decelerators 40a-40d have a dedicated length in each case, i.e. mutually different lengths in each case. The beam decelerators 40a-40d can have the same cross section, in particular a polygonal, preferably round, cross section. Only four beam decelerators 40a-40d are illustrated in FIG. 2 for reasons of clarity. However, the beam deceleration device 36 can comprise more, in particular more than 10, preferably more than 20, beam decelerators 40a-40d.

The beam decelerators 40a-40d can be arranged or configured in the form of a two-dimensional array. The beam decelerators 40a-40d emit the secondary light beams 14b onto the sample 12 in each case with individual temporal retardation. This is illustrated in FIG. 2 by wave packets having propagated to different extents between the beam decelerators 40a-40d and the surface of the sample 12. In order to increase the effectiveness of the beam deceleration device 36, the latter can comprise an antireflection coating 42 on its input side and/or on its output side (not shown).

In the sample 12, the secondary light beams 14b initiate local thermal expansions and the latter (as explained with regard to FIG. 1) initiate acoustic waves, which are registered by the electroacoustic transducer 20. The oscilloscope 22 represents the signals of the electroacoustic transducer 20. Since it is known which secondary light beam 14b is temporally retarded to what extent, and it is furthermore known which secondary light beam 14b impinges where on the sample 12, the output signals of the electroacoustic transducer which are output in a specific order can be assigned to specific sample positions.

In the schematic example in FIG. 2, the first output signal of the electroacoustic transducer 20 would be assigned to the sample position which was illuminated by the secondary light beam 14b which did not pass through a beam decelerator. The second output signal would be assigned to the secondary light beam 14b which passed through the beam decelerator 40a, or to the sample position assigned by this secondary light beam 14b. The third output signal correlates with the secondary light beam 14b which passed through the beam decelerator 40b, etc. Although a large portion of the sample 12 is illuminated almost simultaneously by a single light source 28, the output signals of the electroacoustic transducer 20 can be assigned to specific positions on the sample 12 in a spatially resolved manner.

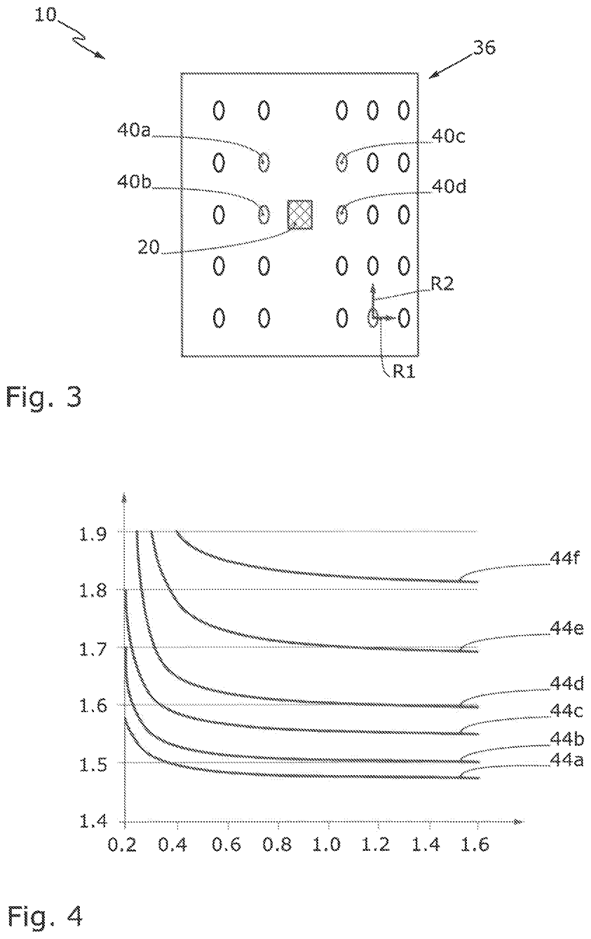

FIG. 3 shows a plan view of a part of a further apparatus 10 comprising a beam deceleration device 36. An electroacoustic transducer 20 is arranged or configured in the middle or centrally in or on the beam deceleration device 36. Beam decelerators, of which only beam decelerators 40a-40d are provided with a reference sign for reasons of clarity, are each at an individual distance from the electroacoustic transducer 20 in order to enable an unambiguous assignment of the secondary light beams 14b passing through the beam decelerators 40a-40d. The beam decelerators 40a-40d are spaced apart from one another in two different directions R1, R2 in order to attain an areal illumination of a sample 12 (see FIG. 2) with a plurality of spots.

FIG. 4 shows a diagram in which the refractive index on the ordinate is plotted against the light wavelength on the abscissa. The refractive index of some materials that are preferably able to be used in beam decelerators 40a-40d (see FIGS. 2 and 3) is plotted in FIG. 4. In this case, the refractive indices of fluorite crown FK51A 44a, borosilicate crown BK7 44b, barium crown BaK4 44c, flint F2 44d, dense flint SF10 44e and lanthanum dense flint LaSF9 44f are plotted in FIG. 4.

Different materials or the same material can be used in the beam decelerators 40a-40d. In the case where the same material is used in all of the beam decelerators 40a-40d, the beam decelerators 40a-40d have different lengths or optical retardation paths. The calculation of an optical retardation path is presented below on the basis of an example:

Even a light velocity of the secondary light beam in a vacuum of 299,790,000 m/s and a phase velocity of 187 368 750 m/s in a beam decelerator comprising a material having a refractive index of 1.6, results in a velocity difference of 112,421,250 m/s. In order to achieve a temporal retardation of the secondary light beams of 1 ns, the optical retardation path (in accordance with v=s*t) has to have a length of 112 mm. If the oscilloscope is configured to achieve 160 Gsamples/s, the output signal thus generated by the electroacoustic transducer can still be sampled 160 times.

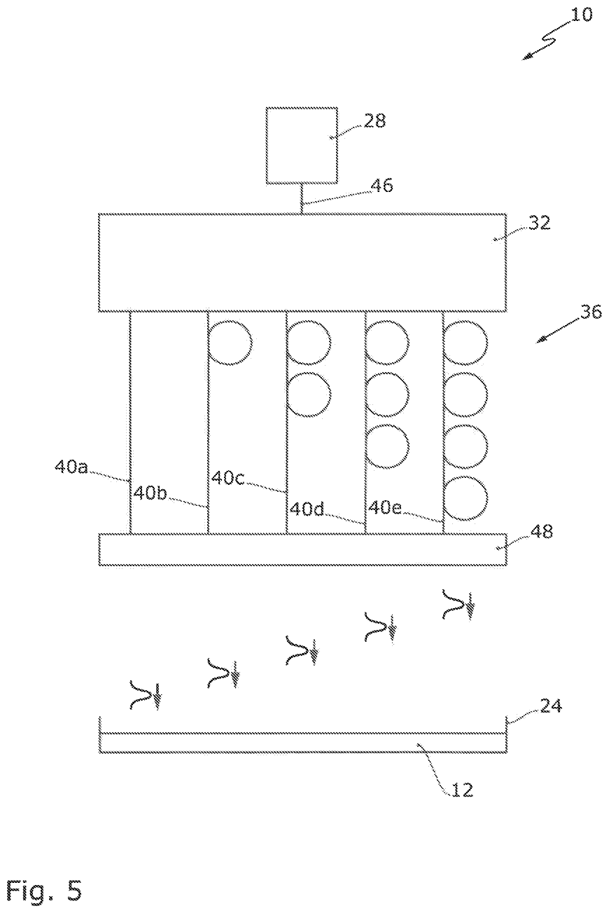

FIG. 5 shows an apparatus 10 comprising a light source 28 configured in particular for generating laser light pulses. The light source 28 is connected to a beam splitter 32 optically, in particular via a fiber connection 46. The beam splitter 32 is configured in fiber-optic fashion, i.e. in the form of a fiber splitter. A beam deceleration device 36 comprises a plurality of beam decelerators 40a-40e. The beam decelerators 40a-40e are configured in each case in the form of an optical fiber. The beam decelerators 40a-40e are preferably configured identically, apart from their respective length. The different lengths of the beam decelerators 40a-40e are illustrated schematically by loops in FIG. 5.

If a light beam is retarded for example via an additional fiber path of 1 m, then the laser beam propagates in a fiber in the form of an optical fiber (refractive index of quartz 1.45) with a phase velocity of 206,751,724 m/s. This results in a temporal retardation of 4.85 ns.

The beam deceleration device comprises an optical head 48. At the optical head, the light beams coming from the beam decelerators 40a-40e emerge in the form of free beams and impinge on a sample 12 or a sample holder 24. The optical head 48, analogously to the illustration in FIG. 3, can be configured with two-dimensionally arranged exits for the light beams in order to be able to scan the sample 12 two-dimensionally.

Taking all the figures of the drawing jointly into consideration, the disclosure thus relates in summary to an apparatus 10 for illuminating a sample 12 with a plurality of light beams 14, 14b succeeding one another in synchronized fashion. Acoustic waves 18 generated by these light beams 14, 14b on the sample 12 are detected by an electroacoustic transducer 20. The synchronous sequence of the light beams 14, 14b can be achieved by means of a beam deceleration device 36 comprising at least one beam decelerator 40a-40e, preferably a plurality of beam decelerators 40a-40e. The beam decelerators 40a-40d can each bring about individual retardations of the light beams 14b passing through them, i.e. retardations that are different in relation to the other beam decelerators 40a-40e. As a result, a large surface area of the sample 12 can be scanned with rapidly successive light beams 14b that are assignable to the respective illumination position. The beam deceleration device 36 can be illuminated by a beam splitter 32. The beam splitter 32 and/or the beam deceleration device 36 can be configured in a planar fashion. In a preferred embodiment, proceeding from the light source 28 until the light beams emerge from an optical head 48 of the beam deceleration device 36, the apparatus 10 comprises predominantly, in particular completely, fiber-optic components.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

10 Apparatus
12 Sample
14 Light beam
14a Primary light beam
14b Secondary light beams
16 Thermal expansion
18 Acoustic wave
20 Electroacoustic transducer
22 Oscilloscope
24 Sample holder
26 Light beam device
28 Light source
30 Collimator
32 Beam splitter
34 Antireflection coating (of the beam splitter 32)
36 Beam deceleration device
38 Plate
40a-40e Beam decelerator
42 Antireflection coating (of the beam deceleration device 36)
44a Refractive index of fluorite crown FK51A
44b Refractive index of borosilicate crown BK7
44c Refractive index of barium crown BaK4
44d Refractive index of flint F2
44e Refractive index of dense flint SF10
44f Refractive index of lanthanum dense flint LaSF9
46 Fiber connection
48 Optical head
R1, R2 Directions (of the spacings of the beam decelerators 40a-40e)

What is claimed is:

1. An apparatus for carrying out spatially resolved photoacoustics, the apparatus comprising:
a sample holder configured to receive a sample to be examined;
an electroacoustic transducer in the region of the sample holder configured to detect acoustic waves excited by light beams on the sample; and
a light beam device configured to emit a plurality of light beams that are spatially and temporally separated from one another onto the sample in order to generate acoustic waves at spatially separated positions on the sample.

2. The apparatus as claimed in claim 1, wherein the light beam device comprises:
a single light source configured to emit a primary light beam;
a beam splitter configured to split the primary light beam of the light source into a plurality of secondary light beams; and
a beam deceleration device comprising a beam decelerator configured to decelerate one of the secondary light beams in relation to a further one of the secondary light beams in order to achieve retarded impingement of the secondary light beam in relation to the further secondary light beam on the sample.

3. The apparatus as claimed in claim 2, wherein the beam deceleration device comprises a plurality of differently retarding beam decelerators configured to retard secondary light beams differently and thus to cause them to impinge on the sample in each case with a temporal offset with respect to one another.

4. The apparatus as claimed in claim 3, wherein the beam decelerators are arranged or configured two-dimensionally in mutually different directions at the beam deceleration device, such that the secondary light beams impinge on the sample in the region of a two-dimensional area.

5. The apparatus as claimed in claim 2, wherein a beam decelerator comprises a high refractive index glass and/or a high refractive index plastic.

6. The apparatus as claimed in claim 2, wherein a beam decelerator comprises an optical fiber.

7. The apparatus as claimed in claim 2, wherein the beam deceleration device comprises a plate with at least one beam decelerator, the plate being transparent to the secondary light beams at least in sections.

8. The apparatus as claimed in claim 7, wherein the plate is configured in an integral fashion.

9. The apparatus as claimed in claim 2, wherein the beam splitter comprises a diffractive optical element and/or a microlens array for splitting the primary light beam into the secondary light beams.

10. The apparatus as claimed in claim 2, wherein the electroacoustic transducer is integrated into the beam deceleration device.

11. The apparatus as claimed in claim 1, wherein the apparatus comprises an oscilloscope configured to process and/or represent the output signal of the electroacoustic transducer.

12. The apparatus as claimed in claim 2, wherein the beam splitter is configured in the form of a fiber splitter.

13. A method for carrying out spatially resolved photoacoustics, the method comprising:
splitting a primary light beam into a plurality of secondary light beams;
irradiating a sample with the secondary light beams, wherein a first secondary light beam is retarded in relation to a further secondary light beam, such that the first secondary light beam impinges on the sample after the further secondary light beam;
detecting acoustic waves excited on the sample by the secondary light beams.

14. The method as claimed in claim 13, wherein a pulsed light beam is used as the primary light beam.

15. The method as claimed in claim 13, wherein two secondary light beams are retarded by between 0.01 ns and 10 ns with respect to one another.

16. The method as claimed in claim 15, wherein all the secondary light beams are retarded by between 0.01 ns and 50 ns in each case with respect to another secondary light beam.
